(19) United States
(12) Patent Application Publication
(10) Pub. No.: US 2011/0296975 A1
(43) Pub. Date: Dec. 8, 2011

(54) APPARATUS COMPRISING A BASE AND A FINGER ATTACHMENT

(75) Inventor: Anastasius Prosper Anselmus de Jong, Leiden (NL)

(73) Assignee: Universiteit Leiden, Leiden (NL)

(21) Appl. No.: 12/792,432

(22) Filed: Jun. 2, 2010

(51) Int. Cl. G10H 3/14

(52) U.S. Cl. 84/725

(57) ABSTRACT

Apparatus comprising a base, a finger attachment, and an electromagnet. The base comprises a proximity detector configured to determine an input distance between the finger attachment and the base. The apparatus further comprises a converter configured to convert the input distance between the finger attachment and the base into an output force to be applied to the finger attachment. The electromagnet is configured to apply a force to the finger attachment in accordance with the output force to be applied to the finger attachment as determined by the converter.

### BACKGROUND OF THE INVENTION

This disclosure relates to apparatus comprising a base and a finger attachment, and in particular, although not exclusively, apparatus that is configured to determine a distance between the finger attachment and the base, and apply a force to the finger attachment in accordance with the determined distance.

### SUMMARY OF THE INVENTION

According to a first aspect of the invention, there is provided apparatus comprising:

a base;

a finger attachment; and

an electromagnet;

wherein the base comprises a proximity detector configured to determine a distance between the finger attachment and the base;

the apparatus further comprising a converter configured to convert the distance between the finger attachment and the base into a force to be applied to the finger attachment; and

wherein the electromagnet is configured to apply a force to the finger attachment in accordance with the force to be applied to the finger attachment as determined by the converter.

The distance between the finger attachment and the base may be considered as an input, and the force to be applied to the finger attachment may be considered as an output.

The apparatus can provide advantageous functionality for a user to interact with a computer system, whereby a cyclical relationship between the input (distance between the finger attachment and the base) and the output (force to be applied to the finger attachment) can be provided. Use of an electromagnet can avoid the need for any mechanical linkages between the finger attachment and the base.

The converter can provide a convenient implementation for enabling a specific force to be applied to the finger attachment. In some embodiments, the base may also comprise the electromagnet.

The output force may comprise a first force component that is configured to move the finger attachment, thereby changing the distance between the finger attachment and the base. In this way, kinesthetic feedback can be provided to a user.

The output force may comprise a second force component that is configured to vibrate and/or pulsate the finger attachment, thereby not substantially changing the distance between the finger attachment and the base. In this way, cutaneous feedback can be provided to a user, which may be in addition to, or instead of, kinesthetic feedback. The second force component may be configured to vibrate and/or pulsate the finger attachment with relatively small amplitude. It will be appreciated that the wave forms and base frequencies underlying the pulsation/vibration can be arbitrary, and can be made to vary over time. The variation over time may be due to a change in the distance between the finger attachment and the base and/or in accordance with an instruction received from a processor/computer associated with the apparatus.

The converter may be configured to convert the distance between the finger attachment and the base into a force to be applied to the finger attachment using a look-up table of data values. The converter may also use interpolation to process values that are not included in the look-up table. This can provide a computationally simple implementation of the converter, and can provide advantages in terms of latency and processing speed, and can also enable implementation of the converter by computing hardware that has limited processing power (for example, embedded systems).

The converter may be further configured to convert the force to be applied to the finger attachment to a driving current/voltage for the electromagnet, and this may be in accordance with both the distance between the finger attachment and the base and the force to be applied to the finger attachment. This can enable a desired force to be applied accurately, as it can take into account variables that are known to influence the current that is required to provide the desired force.

The converter may be configured to use a look-up table to determine the driving current for the electromagnet based on the distance between the finger attachment and the base and the force to be applied to the finger attachment. The data in the look-up table may be determined empirically such that environmental conditions and any other variables can be taken into account, and a more accurate force output can be provided. Use of a look-up table can also provide an implementation that can determine the output force quickly after receiving the input distance.

The finger attachment may be mechanically independent from the base, and this can improve the usability of the finger attachment, and enable more “natural” actions and movements to be made by a user. Also, this can make it easier and faster for the user to initiate, terminate and/or re-initiate interactions involving the base and finger attachment within the context of other or wider activities. The finger attachment may comprise a magnet, which may be a permanent magnet, for experiencing the force from the electromagnet. In other examples, any magnetizable metal could be used to experience a force from the electromagnet.

The finger attachment may comprise a reflector configured to reflect light (such as infra-red light) that is received from the proximity detector, back to the proximity detector such that the proximity detector can determine the distance between the finger attachment and the base. An advantage of such an embodiment is that the finger attachment can be kept relatively small, lightweight and manoeuvrable, as it does not need bulky components such as electronic sensors (which may include the use of accelerometers) and power supplies to be able to provide proximity detection.

The reflector may comprise a first and second layer reflector layer. The first layer may be a specular reflector layer, such as a layer that has a high value for reflectivity, for example a reflectivity that is greater than 80%, 90%, or 95%. The second reflector layer may be a diffuse reflector layer, such that the incident light is reflected back with a wide enough field of view that any offsets in the orientation of the reflector do not prevent the apparatus from operating.

The converter may be configured to convert the distance between the finger attachment and the base into a zero force that is to be applied to the finger attachment. In this way, an inactive surface can be provided such that the operating conditions of the electromagnet (such as the current) are adjusted in order to ensure that the electromagnet does not apply a biasing force to the finger attachment. This can enable an apparatus with an electromagnet to be used in applications that do not require a biasing force to be applied to the finger attachment, yet can still be used to receive a signal representative of user input.

The converter may be configured to convert the distance between the finger attachment and the base into a force that will bias the finger attachment to a predetermined distance/position from the base. In this way, the apparatus can be configured to try and keep the finger attachment stationary in a predetermined position, and a deviation from the predetermined position can be considered as user input. For example, a force that is applied to the finger attachment by the electromagnet and/or a distance of the finger attachment from the predetermined position can be identified as indicative of a user's instructions/input. In one example, the analogue distance that a user moves the finger attachment against the restorative force (that attempts to bring the finger attachment to the predetermined position) can be considered as analogue user input. For example, as a user pushes harder against the force, a louder musical note may be provided. In another example, where the finger is kept stationary, the restorative force that is applied by the electromagnet will be the same as the force applied by the user, and the value of the restorative force can be taken as representative of user input.

The converter may be configured to periodically sample the distance between the finger attachment and the base, and only convert the distance between the finger attachment and the base into a new/updated/changed force to be applied to the finger attachment if the difference between (1) a current/present value for the distance between the finger attachment and the base and (2) the last value for the distance between the finger attachment and the base that was converted into a force, is in excess of a sensitivity threshold value. If the difference between (1) the current value for the distance between the finger attachment and the base and (2) the last value for the distance between the finger attachment and the base that was converted into a force, is not in excess of the sensitivity threshold value, then the force is not determined/adjusted. This may be referred to as sensitivity thresholding, and can enable processing-efficient (and therefore a quick) implementation that can account for noise in the input signal.

The converter may be configured to determine the velocity of the finger attachment from the determined distance between the finger attachment and the base, and determine the force to be applied to the finger attachment using both the velocity of the finger attachment and the determined distance between the finger attachment and the base.

The converter may be configured to determine the force to be applied to the finger attachment for a future instance in time in accordance with the velocity of the finger attachment and the determined distance between the finger attachment and the base. This can enable pre-scheduling of the output, and further improve the latency of the apparatus. The output can be considered as providing a response based on an expectation of what is going to happen.

There may be provided a musical device comprising any apparatus disclosed herein, wherein the base represents a musical instrument, and a user can interact with the base by moving, or attempting to move, or holding still the finger attachment relative to the base. This may be configured to occur while a force is applied to the finger attachment by the electromagnet. In some examples, the force could be at a level of 0 Newtons.

There may be provided a user interface comprising any apparatus disclosed herein, wherein the base represents a display, and a user can interact with the base by moving, or attempting to move, or holding still the finger attachment relative to the base. This may be configured to occur while a force is applied to the finger attachment by the electromagnet. The display may be a keypad, an alphanumeric keyboard, a numeric keypad, a projected display, a touch screen display, an interactive display or any illustration with which a user can interact.

There may be provided a finger attachment for coupling to a user's finger comprising:

a vibrator; and

a finger coupler coupled to the vibrator, wherein the finger coupler is configured to be located between the vibrator and a user's finger in use such that vibrations are coupled from the vibrator to the user's finger;

wherein the finger coupler is configured to interact with different mechanoreceptors in the user's finger over time.

The vibrator may be a magnet that is configured to be exposed to a time-varying magnetic field such that a time-varying force is applied to the magnet.

The finger coupler may comprise a rough or uneven surface, or a deformable surface/layer such as a foam layer. In this way, the finger coupler may contact different regions of a user's skin over time as the vibrator vibrates, thereby interacting with different mechanoreceptors. This can lead to a reduction in neural adaptation, and improved performance.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

There now follows a description of preferred embodiments of the invention, by way of non-limiting example, with reference to the accompanying drawings in which:

FIG. 1 illustrates an apparatus according to an embodiment of the invention;

FIG. 2 illustrates graphically the data in a look-up table according to an embodiment of the invention;

FIG. 3 illustrates an apparatus according to another embodiment of the invention;

FIGS. 4a and 4b illustrate an apparatus according to another embodiment of the invention;

FIGS. 5a, 5b, 5c and 5d illustrate an apparatus according to a further still embodiment of the invention;

FIGS. 6a, 6b and 6c illustrate an apparatus according to a further still embodiment of the invention;

FIG. 7 illustrates a finger attachment according to an embodiment of the invention;

FIGS. 8a,8b and 8c illustrate an electromagnet according to an embodiment of the invention; and

FIGS. 9a, 9b and 9c illustrate finger attachments according to embodiments of the invention.

### DETAILED DESCRIPTION OF THE INVENTION

A description of example embodiments of the invention follows.

[OPTIONAL The teachings of all patents, published applications and references cited herein are incorporated by reference in their entirety.]

One or more embodiments described herein relate to an apparatus that can determine a distance between a finger attachment and a base, which can be considered as an input, and can use an electromagnet to apply a force to the finger attachment in accordance with the determined distance. The force may be considered as an output. The apparatus may comprise a converter, which may be embodied in software, for converting the determined distance into a required force, and optionally to a current value that should be provided to the electromagnet in order to generate the required force on the finger attachment.

The converter can convert the distance into a first force component and a second force component, wherein the first force component is configured to move a finger, and may be known as kinesthetic feedback, and the second force component is configured to stimulate the skin of the finger, without substantially moving the finger, and may be known as cutaneous feedback. The first force component can directly influence the input distance between the finger attachment and the base, thereby providing a cyclical relationship between the input and the output.

Apparatus according to embodiments of the invention can provide advantages in the music industry, whereby virtual keyboards/pianos (or any other instrument) can be provided as the force that is applied to a user's finger can be configured such that it mimics the response of a real keyboard/piano. The apparatus may also be configured to produce a sound representative of the real instrument.

Embodiments disclosed herein can enable a responsive apparatus to be provided, for example one with high temporal resolution, and this can be advantageous for examples that are used with musical applications. Providing short latency and fast processing abilities can enable operation of the apparatus to be performed satisfactorily.

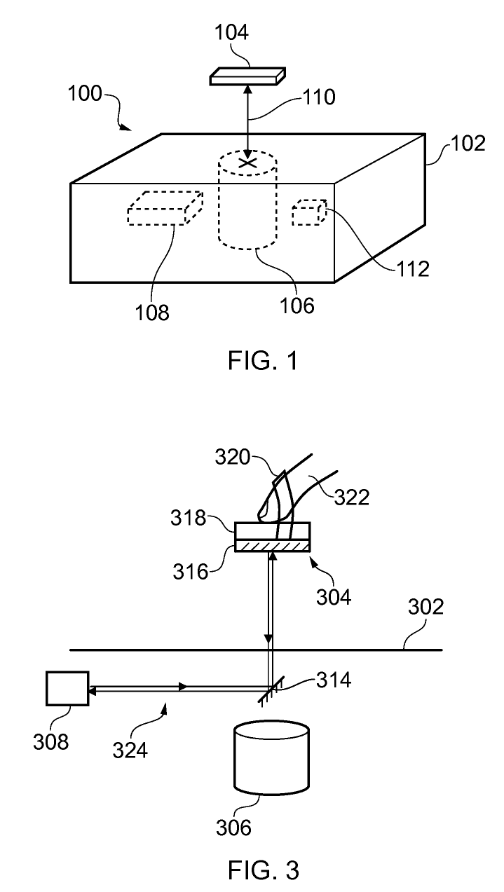

FIG. 1 illustrates an apparatus 100 according to an embodiment of the invention. The apparatus comprises a base 102 and a finger attachment 104. The base will generally be stationary and located on a table top, for example. The finger attachment 104 is suitable for placing over a user's finger (not shown in FIG. 1).

The base 102 includes a proximity detector 108 that is configured to determine a distance between the base 102 and the finger attachment 104, this distance is shown graphically with reference 110 in FIG. 1. In some embodiments, distances between 0.00 and about 61.00 mm can be measured. The base also includes an electromagnet 106 that is configured to apply a force to the finger attachment 104. In this example, the proximity detector 108 and electromagnet 106 are co-located within the base, although it will be appreciated that in other embodiments, the proximity detector 108 and/or electromagnet 106 may be located in different positions, not necessarily within the base 102, and still perform the same function.

In this embodiment, the finger attachment includes a permanent magnet that can be attracted to, or repelled from, the electromagnet 106 in accordance with the current that is flowing through the electromagnet 106. In some prior art examples, it has not been possible to reliably control when, and by how much, a permanent magnet is attracted to/repelled from an electromagnet. In particular, it may not be possible with the prior art to provide feedback in a short enough time that a meaningful system can be provided, and this may be especially true in musical applications where any delay in the feedback can lead to sub-optimal performance of the apparatus.

The apparatus also includes a converter 112, which in this embodiment is provided by computer software. The converter 112 can convert the distance 110 between the finger attachment 104 and base 102 that has been determined by the proximity detector 108 into a desired force to be applied to the finger attachment, and provide the electromagnet 106 with a signal that causes it to apply the desired force to the finger attachment 104.

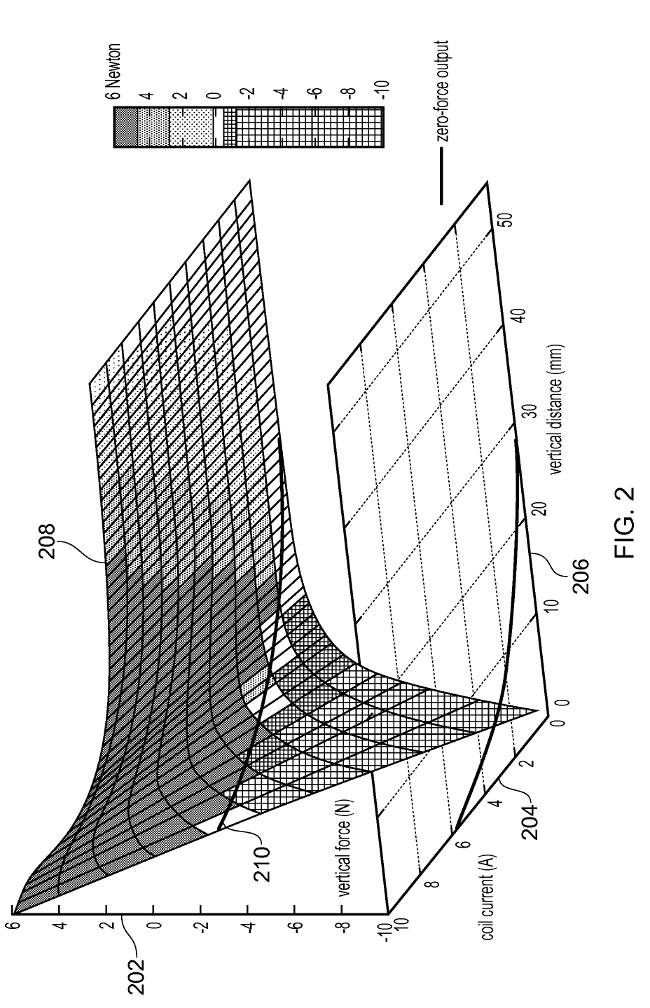

An example of a converter 112 that (1) converts the determined distance between the base 102 and the finger attachment 104 into a desired force; and then (2) converts the desired force into a current that is to be provided to the electromagnet 106, will be described with reference to the graph of FIG. 2.

Stored in a computer memory associated with the apparatus 100 can be a look-up table (or database, or any other data store) that provides a correlation between distance (between the base 102 and the finger attachment 104) and force (to be applied to the finger attachment 104). This correlation can be configured according to a user's specific needs, for example to mimic or create the feel of a musical instrument. When a distance is provided by the proximity detector 108, the converter 112 uses the look-up table to identify a desired output force. If the distance that is provided by the proximity detector 108 falls between two values that are stored in the look-up table, then the converter 112 can use interpolation between the two values to determine an interpolated desired output force.

After the converter 112 has determined the desired output force, it can use a further look-up table (or database, or any other data store) to determine a current that should be provided to the electromagnet to generate the desired force. Again, interpolation can be used. A graphical representation of such a further look-up table is provided by FIG. 2. In some embodiments, the force that is applied through the application of FIG. 2 can be considered as kinesthetic feedback as it is configured to move the finger attachment, and hence the user's finger.

As shown in FIG. 2, the look-up table has three dimensions/axes: a first dimension relates to the measured distance, and is shown in FIG. 2 as axis 206; a second dimension relates to the desired force as determined from the first look-up table, and is shown in FIG. 2 as axis 202; and a third dimension is the associated coil current that is required to provide the desired force at the measured distance, and is shown in FIG. 2 as axis 204.

The plane 208 that is shown in FIG. 2 represents the values of the data in the look-up table, and it can be seen that in order to provide a zero-force output (as represented by line 210 in FIG. 2), a non-zero coil current is required for all distances below about 28 mm.

Paradoxically, in order for the apparatus to be capable of behaving as an inactive surface, the electromagnet 106 may have to actively apply the zero-force characteristic 210 shown in FIG. 2 to counteract magnetization of the electromagnets 106 core by the permanent magnet of the finger attachment 104.

It has been appreciated that fixed-current force curves can be non-monotonous over distance, for example, the force projected by the same fixed current level may be an attractive force or a repulsive force depending upon the distance between the finger attachment and the base. This can be seen in FIG. 2.

It has been appreciated that in some embodiments it can be disadvantageous for the coil current to be calculated based solely on the force that is to be applied, as, without information relating to the distance between the finger attachment and base, it may not be possible to control the magnitude, or even the direction, of the force.

In some embodiments, use of look-up tables as provided above can be considered as advantageous over performing complicated equations, as the computational processing load can be decreased when implementing look-up tables. This can decrease latency between haptic input and output due to shorter processing times, and enable or support application in systems with limited computational resources, such as embedded systems.

Also, the use of look-up tables can provide an efficient and convenient way to dynamically and instantaneously change the general or partial force-over-distance response, or general or partial force-over-speed response (for embodiments where the speed is calculated from the change in distance over time) of the apparatus before or during operation.

Such changes can be implemented, for example, by storing multiple pre-computed look-up tables in memory, and (dynamically) combining them or switching between them as required; or (dynamically) adjusting pre-computed look-up tables in part or whole by applying computationally inexpensive mathematical operations to them during operation; or any other method of on-the-fly generation of look-up tables can be used.

Such changes can be made over time, possibly depending on the current stage or mode of interaction or control with the device; in response to specific user input, for example in reaction to specific user movement; or in response to a user's needs, for example before or during operation to adjust to an individually comfortable output force range, as non-limiting examples.

As look-up tables according to some embodiments disclosed herein can be changed dynamically and instantaneously during operation, many complex algorithmically defined interactive behaviours are implementable.

Further still, any variations in environmental conditions and component values can be accounted for by determining the values for the look-up table shown in FIG. 2 empirically, and this may not be possible for examples that use formulae for calculating a required current. In this way, the use of empirically determined look-up tables can provide a verified indication of achievability as well as the verified execution for all output force levels being required of the system at any of its possible distance input levels.

In addition to, or instead of, providing kinesthetic feedback to a user's finger, one or more embodiments disclosed herein can be provided to a user's finger in order to provide an alternative means of providing feedback to a user. The cutaneous feedback may be considered as providing vibrating or pulsating force feedback to the skin of a user's finger. The values for the force that is to be applied to the user's finger in order to provide cutaneous feedback, and also the current that is to be applied to the electromagnet, may be determined in a similar way to that described above with regard to FIG. 2. As described in more detail below, the force that is to be applied is varied over time in order to vibrate the user's finger. Therefore, force/current values that are returned from a look-up table can be varied over time in order to provide a vibration effect.

The vibrating force may be constructed using wave forms which are stored as a series of amplitude values in one or more look-up tables. The values can be read out, and possibly interpolated if required, over time, and indexed by a temporally incrementing phase parameter. That is, the amplitude of the force can vary over time so as to provide the user with a vibrating or pulsating sensation without significantly changing the position of the user's finger. The contents of such a look-up table may be read out once, or repeatedly according to some (possibly changing) base frequency, to form a digital signal that is configured to change the force to be applied to the finger attachment over time. This signal may be referred to as a “cutaneous signal”.

The resulting wave forms can be pulse waves, sine waves, or any other arbitrary wave form that varies over time. The cutaneous signal may be configured to provide a force that contains pulses or longer repeated oscillations according to any such waveform.

In some examples, the cutaneous signal may also be attenuated by an envelope signal developing over time. The envelope signal may constitute an arbitrary amplitude series, attuned so as to provide some desired vibratory output effect over time. The amplitude series can be read out from a look-up table (as described above) that is indexed by a phase parameter that increments over time. Such a look-up table may be considered as a dynamic look-up table, and can be very similar in type to the ones described above. Initiation of an envelope's read-out can be triggered by some event. The occurrence of such trigger events over time may be due to a change in the distance between the finger attachment and the base and/or in accordance with an instruction received from a processor/computer associated with the apparatus.

In examples where the apparatus is configured to apply both kinesthetic and cutaneous feedback to a user, the cutaneous signal may be added to, or modulated onto, another digital signal. The other digital signal may provide a bias level, for example to provide kinesthetic feedback, and the combined signal can be used to control the force output of the apparatus.

In examples where the haptic output is to be cutaneous only, the amplitude range of the cutaneous signal can be scaled (attenuated) until its resulting force is considered small enough such that it does not cause kinesthetic finger movement. In one example, the amplitude range of the cutaneous signal can be scaled down such that all of its values are below a threshold vale that is considered to represent a force that will move a user's finger.

Similarly, in order to introduce a kinesthetic component, the cutaneous signal could also be scaled up until its resulting effect involves the whole finger oscillating or being pulsed up and down. In one such example, the amplitude range of the cutaneous signal can be scaled up such that one or more of its values are above a threshold value that is considered to represent a force that will move a user's finger.

The human cutaneous sense of vibration and pressure is conveyed by mechanoreceptors in the skin. These mechanoreceptors are subject to the well-known phenomenon of neural adaptation, where a fixed stimulus (for example, a light constant pressure, or a fixed-frequency, fixed-amplitude vibration) over time is perceived as becoming less intense or is even not perceived anymore at all. That is, a user gets used to the vibration and does not notice it any more, or as much, over time.

When sensing vibration on surfaces by making contact with the human fingerpad, it has been observed that continuous, possibly small, movement of the user's fingerpad across the vibrating surface can significantly decrease the perceived effects of neural adaptation, allowing for a more sustained and pronounced vibratory sensation, and therefore improved performance. This has been found to be especially the case for textured or uneven surfaces.

The perceived decrease in the effects of neural adaptation is thought to be at least partly due to different mechanoreceptors in the user's finger becoming stimulated during different time periods during such movement. This is due to the changing contact areas between the skin and vibrating surface during vibration which can be enhanced by using a contact surface that is not smooth.

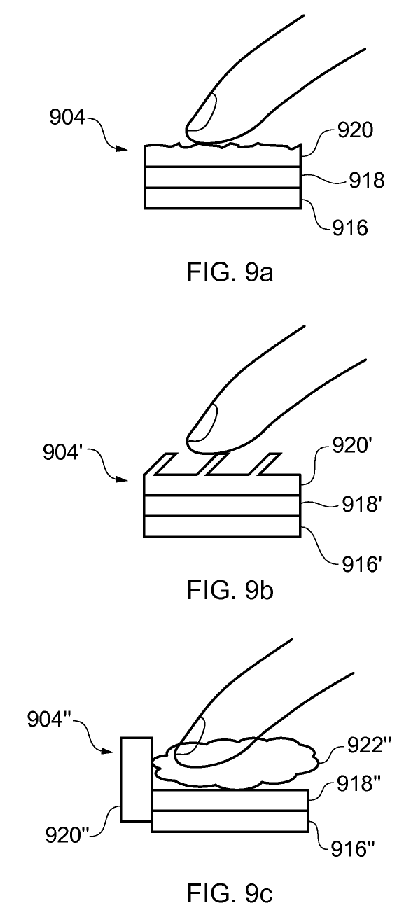

Examples of textured or uneven surfaces that can be coupled to the magnet of the finger attachment and located next to a user's fingerpad are shown in FIGS. 9a to 9c.

FIG. 9a illustrates a finger attachment 904 having a reflector 916 and a magnet 918. The strap for attaching to the user's finger is not shown in FIG. 9a in order to aid clarity. The finger attachment 904 also includes one or more layers of cardboard 920 on top of the magnet 918, where the layer of cardboard 920 has a slightly rough surface in contact with the user's finger. The layer of cardboard 920 is coupled to the magnet 918 such that it vibrates when the magnet 918 vibrates.

FIG. 9b illustrates an alternative embodiment, whereby a layer having an otherwise smooth surface with added ridges of cut rubber or copper wire 920′ is placed on top of the magnet 918′.

In some examples, it may be considered undesirable to move the skin (for example fingerpad skin) relative to the vibrating surface (for example the vibrating magnet of the finger attachment) in order to increase the transfer of sensed vibration. An embodiment that can provide improved vibration to a user's finger without moving the finger relative to the vibrating surface is shown in FIG. 9c.

FIG. 9c illustrates a finger attachment having a rigid protrusion 920″ coupled to an end surface of the magnet 918″. The end surface may be considered as a surface that is perpendicular to the plane of the magnet 918″, and can be considered as an extension of the vibrating surface as it will vibrate in the same way as the magnet 918″. The finger attachment 904″ also includes a deformable material 922″, for example foam/polyether foam, that is attached on one side to the rigid protrusion 920″.

On another side of the deformable material 922″, the deformable material 922″ is configured such that it presses lightly to the user's skin when it is in use. In this way, the deformable material 922″ can remain free to make small oscillatory movements during the output and transfer of vibration, and thus can also make small movements relative to the local skin surface being touched such that different mechanoreceptors in the user's finger are exposed to the vibrating deformable material 922″ over time.

The use of a deformable material has been found to increase the transfer of sensed vibration, and this may be due to:

increasing the total skin area in contact with vibration-conducting material;

the lighter touch (lower mean pressure on the skin) for the additional vibrating contact surface resulting in less hampered vibrations;

decreased cutaneous neural adaptation through local movement of the vibrating contact area.

FIG. 3 illustrates an embodiment of the invention that illustrates how the proximity detector 308 and electromagnet 306 can interact with the finger attachment 304. FIG. 3 represents a schematic cross-sectional view through the base 302 and the finger attachment 304, whereby those components that are shown below line 302 (which represents an upper surface of the base) in FIG. 3 can be considered as being located within the base 302.

The finger attachment 304 of this example comprises a permanent magnet 318 (as discussed in more detail below) for use with the electromagnet 306, and a reflective surface 316 for use with the proximity sensor 308. The finger attachment 304 also has a strap 320 for attaching to a user's finger 322. It will be appreciated that the finger 322 and attachment 304 are not drawn to scale, and that the finger attachment 304 has been enlarged for ease of illustration. In some examples, a finger attachment having both magnetic and reflective properties may be referred to as a “keystone”.

The electromagnet 306 is configured to apply a force to the permanent magnet 318 of the finger attachment 304.

Provided below the permanent magnet 318, that is nearer the base 302, is a reflector 316. It will be appreciated that the magnetic field provided by the electromagnet 306 that will apply the force to the permanent magnet 318 can pass through the reflector 316.

The reflector 316 is configured to reflect light 324, in this example infra-red (IR) light, such that the distance between the finger attachment 304 and the top surface of the base 302 can be determined. In this example, an IR light emitter and detector 308 is provided within the base 302. The IR light emitter and detector 308 emits IR light 324 to a mirror 314, which is located between the electromagnet 306 and the finger attachment 304. The mirror 314 is positioned such that it directs the light along a line that is perpendicular to the surface of the base 302, and therefore can determine the straight line distance between the surface of the base 302 and the finger attachment 304.

The reflector 316 reflects the light 324 that has been emitted by the IR light emitter and detector 308 such that it travels back to the IR light emitter and detector 308 via substantially the same path. In some embodiments, the emitted light 324 can be pulsed/modulated according to a certain pattern, and the received light can be demodulated using the known pulse pattern. This is known in the art, and can enable an accurate distance to be determined.

An example of a type of modulation that can be used is to emit the light as a 4000 Hz square wave. This can enable the sensor 308 to be less influenced by environment light. The IR detector 308 can determine the peak-to-peak amplitude of the reflected light 324 for each cycle, and then convert it into a continuous digital signal representative of the distance (in some embodiments, in millimeters) between the detector 308 and the finger attachment 304, which in turn can be converted into the distance between the top surface of the base 302 and the finger attachment 304 as the location of the IR detector 308 relative to the base 302 is known. In some embodiments, these conversions can be performed in software.

Calculating the distance in millimeters can be considered as better than calculating the distance as a normalized proximity between 0 and 1 because the system can allow direct access to an input signal in millimeters and also an output signal in Newtons. In this way, haptic interactions can be algorithmically defined in terms of physical units such as Newtons, millimeters and seconds. This can support use of the apparatus for research where haptic interaction is studied as a physical phenomenon independent of the specific hardware or devices used.

In some embodiments, there may be noise in the input signal representative of the distance between the finger attachment 304 and the base 302, and it can be beneficial to suppress this noise. This can be because any errors in the millimeter signal will propagate through the system such that the force that is to be applied to the finger attachment 304 is based at least partly on noise as opposed to the actual distance between the finger attachment 304 and the base 302.

In one embodiment, any noise in the signal representative of the distance between the finger attachment 304 and the base 302 can be reduced by using “sensitivity thresholding”. Sensitivity thresholding can involve periodically comparing/sampling the incoming signal level with a held output signal level, such that the output signal level is held constant until the difference between the output signal level and the incoming signal level is in excess of a sensitivity threshold value. Then, when the sensitivity threshold value is exceeded, the output signal level is adjusted to the input signal level, and the input signal level is again compared with the new output signal level until the sensitivity threshold value is exceeded again, and so on. In this way, changes in the input signal level that are not in excess of the threshold value are ignored, as they are considered to be due to noise. It will be appreciated that a suitable value for the sensitivity threshold value can be set in accordance with a specific application of the apparatus.

This embodiment can be considered as different to simply reducing amplitude resolution to deal with noise. It can also be considered as different to averaging signal amplitude over time, another standard method to deal with noise, which would lower the temporal precision of the apparatus when tracking changes in proximity input, and therefore is able to provide a quick response in terms of output force to be applied to the finger attachment. Issues of temporal precision and latency can be considered as important for haptic systems.

An advantage associated with the embodiment of FIG. 3 is that light 324 can be provided by a light emitter 308 that does not have to be positioned directly between the electromagnet 306 and the finger attachment 304. Positioning the light emitter 308 directly between the electromagnet 306 and the finger attachment 304 may interfere with the magnetic field generated by the electromagnet 306, and can also increase the distance between the finger attachment 304 and the electromagnet 306 thereby requiring a larger current for the electromagnet 306 and consuming more energy. It can also increase the depth of the base 302. Also, positioning the light emitter 308 directly between the electromagnet 306 and the finger attachment 304 can increase the likelihood of deviations from light emitter's 308 normal operation, due to the heat produced by electromagnet 306, and avoiding such deviations in the performance of the light emitter 308 can be considered as an advantage of embodiments of the invention.

In this example, sensing is configured to track the vertical distance to the finger attachment 304 directly above the electromagnet core, so that proximity input to, and force output from, the system are associated with a single physical location. However, the effective sensing range of the reflective IR sensor can begin only millimeters away from the sensor surface. In order to lose as little as possible of the vertical distance range for force output, the sensor 308 is placed to the side of the electromagnet core, horizontally facing a 45° upward-facing mirror 314 placed directly above the core.

In one example, the mirror 314 size is 10 mm×14 mm×1 mm, where the mirror height is 10 mm, and can be trimmed down to a minimum value whilst still being able to perform correctly. This can minimize the distance between the electromagnet 306 and the top surface of the base 302. Two example types of mirror material that can be used with embodiments of the invention, are mirror polystyrol and mirror perspex. These can be polished down to 1 mm thickness. In some examples, mirror perspex can be used as it can give a 98% reflection intensity when compared to an equivalent mirror-less setup, and mirror polystyrol can give 90%.

In some examples, an aperture or hole can be provided in the top surface of the base 302 in order for the IR light 324 to more easily travel between the finger attachment and the IR emitter/detector 308. The hole (not shown in the Figure) can have a diameter that is greater than 10 mm in some embodiments, and can be located directly above the mirror 314. The base can be made from 1 mm thick aluminium, with a thin plastic covering, and this has been found to not significantly interfere with IR reflection. Applying an additional thin layer of light-absorbing tape to the inside-facing side of the aluminium base 302 near the hole can further decrease interference of the base 302 with IR reflection.

Adding a sufficiently thin yet supportive, non-magnetizable/non-magnetizing surface layer or layers (for example, plastic, aluminium) on the top surface of the base (that is, between the user and actuator) can provide the user with a handrest before, during and after operation, while not interfering with magnetic force transfer. This can provide one or more of the following advantages:

it can make use more comfortable;

it can prevent fatigue (and its negative effects on control and interaction);

it can allow for more precise human-controlled positioning input:

while the hand is resting and not moving on the surface, with a finger above a detector, input can be based on finger movement only, which can be more precise than input based on finger movement plus hand movement.

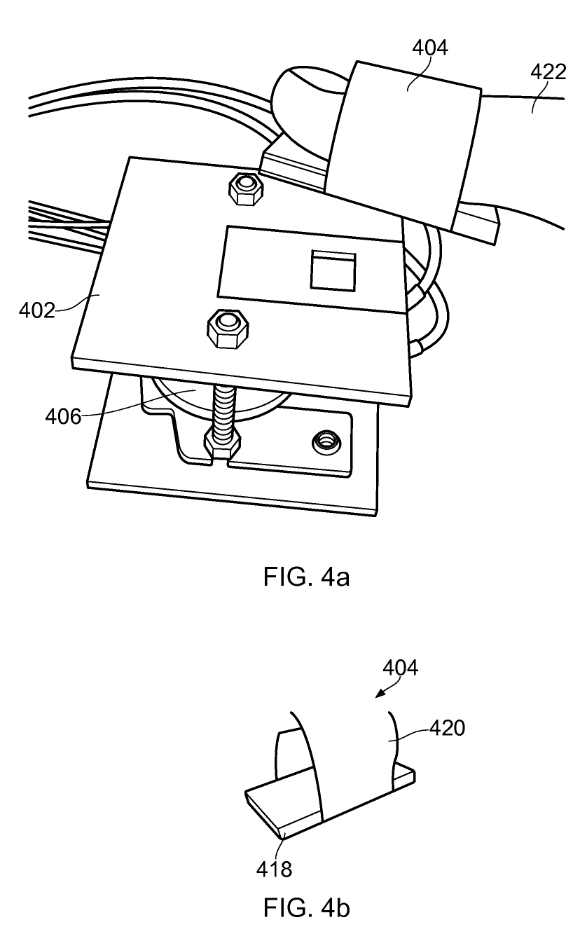

FIGS. 4a and 4b illustrate another embodiment of the invention. FIG. 4a shows a base 402 having an electromagnet 406, and a finger attachment 404 connected to a user's finger 422. FIG. 4b illustrates further detail of the finger attachment 404 when it is not attached to a user's finger, and shows the strap 420 and permanent magnet 418. The reflector cannot be seen in FIG. 4b as it is below the permanent magnet 418. The finger attachment 404 is dimensioned so that the permanent magnet 418 stretches the last two joints of a finger 422 (as shown in FIG. 4a), with its surface placed parallel to the general direction of the finger joints.

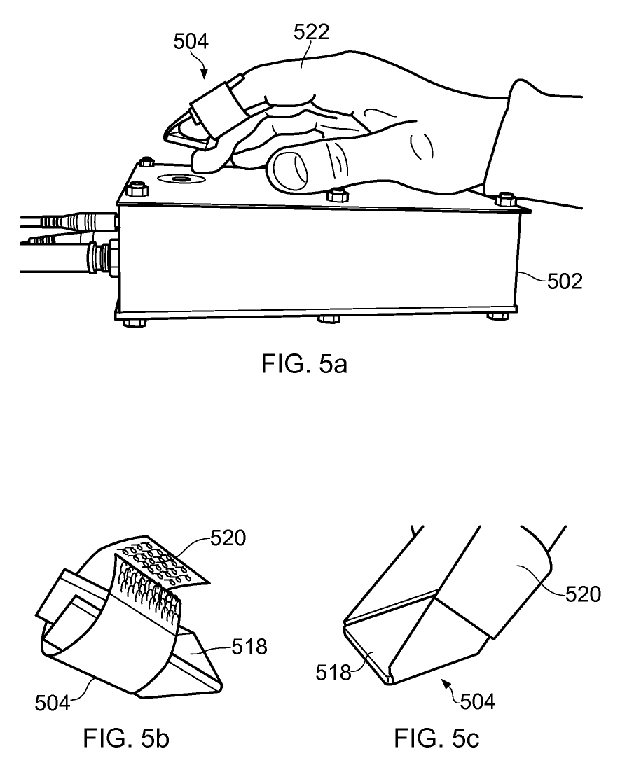

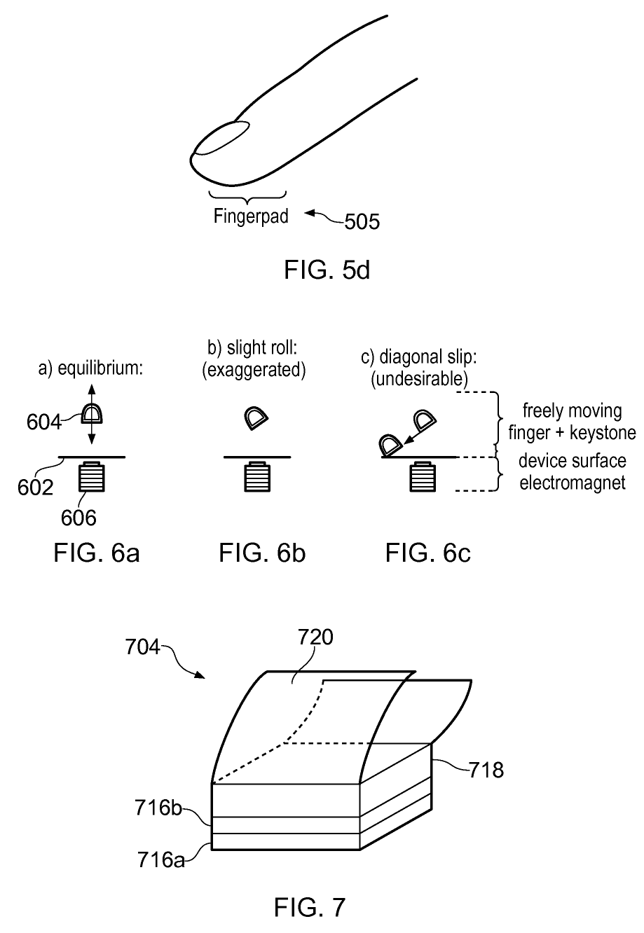

FIGS. 5a to 5c illustrate another embodiment of the invention. FIG. 5a shows a base 502, and a finger attachment 504 connected to a user's finger 522. FIGS. 5b and 5c illustrate further details of the finger attachment 504 when it is not attached to a user's finger, and shows the strap 520 and permanent magnet 518. The finger attachment 504 is dimensioned so that the permanent magnet 518 is pressed against a “fingerpad”, on the last finger joint on a user's finger. Such a fingerpad is shown with reference 505 in FIG. 5d. The “fingerpad” can be considered as an anatomical term for a distal surface of the finger, such as the fingertip. The fingerpad can be considered as having its surface at an angle from the general direction of the finger joint, and is well-known to be extra sensitive to touch due to the increased presence of mechanoreceptors in the skin.

The main surface of the magnet 518 can be orientated such that it is at an angle to the general direction of the finger joint, for example, the angle can be one that places the magnet generally parallel with a top surface of the base 502 when the user's hand is resting naturally on the top surface of the base 502 as shown in FIG. 5a. This angle may be of the order of 40° to 50°, or 30° to 60° for example. It will be appreciated that by providing a suitable strap 520, or other attachment means, that a user can fit the finger attachment 504 to their finger at an angle that is suitable for them.

Advantages associated with the finger attachment 504 of FIG. 5 can include:

allowing a more natural tapping movement for positions where the hand starts from a resting position on or above a surface with the finger relaxed. In some examples, this may be considered as a fundamental interaction between the user and the apparatus.

using the more sensitive skin contact area of the fingerpad can allow for better vibrotactile cutaneous feedback (vibrational output to the skin).

Other aspects that may be taken into account when providing a permanent magnet for use with a finger attachment according to embodiments of the invention can include a consideration of user comfort, whereby for comfortable use, the permanent magnet should be as small and light as possible. A small permanent magnet mass can also be important in order to avoid unnecessarily encumbering fast finger movements by the user.

The choice of permanent magnet, in combination with the electromagnet that is used, should enable a vertically attracting and rejecting output force range to the finger that is wide enough for a desired application, and that is noticeable over a vertical distance range (above the electromagnet core) that is large enough for the desired application. In some embodiments, the desired output force range and desired vertical distance range may be as large as possible, although this can require a large permanent magnet that is in contrast to providing a small, light, comfortable permanent magnet. Therefore, a compromise can be made between the size or mass of the magnet and the required output force and distance range.

The permanent magnet can be made from rubber/ferrite, ceramic/ferrite, or various grades of neodymium. The use of neodymium-based magnetic materials has been found to enable the widest output force ranges, while restricting magnet geometry the least (for example, enabling magnets of smaller volumes).

Embodiments of the invention can be considered as limiting the “slipperiness” of the permanent magnet, or in other words, a “maximum practicable static rejection” (MPSR) can be considered, and this is illustrated in FIGS. 6a to 6c.

Consider the following situation, which may occur in interactions implemented with the apparatus at some point in the vertical distance range. The base 602 generates a constant rejecting (upward) force onto the finger attachment 604, and the user counters this force by applying an equally opposing downward force, thereby resulting in a (temporary) equilibrium. This is shown in FIG. 6a.

It has been appreciated that, as the level of such stable, counteracting forces increases, it is more likely that a roll in the finger's orientation (as shown in FIG. 6b) will increasingly result in a sudden and brisk “diagonal” slip to the base 602, as the finger attachment 604 moves out of the area of the magnetic field generated by the electromagnet 606 located straight above its core, as shown in FIG. 6c.

These movements are “diagonal” in the sense that, when considered in the plane parallel to the electromagnet core's surface (at the vertical location of the finger), they are away from the position directly above the electromagnet core (going either forward, backward, or sideways); and at the same time their direction is downward, towards the surface of the base, in part because this is the direction in which the user is applying a force when the finger attachment slips out of the magnetic field region that was providing sufficient force to balance the user applied force.

In this way, this force-dependent “slipperiness” can limit the practical output force range for a given combination of electromagnet and permanent magnet. For example, the effects of the finger attachment slipping can disturb interactions with the base, as these interactions are based on vertical movements and vertically applied forces. Also, the sideways movements can at some point of displacement decrease, or even remove, the reflection of light from the finger attachment that is used for proximity detection. Therefore, proximity detection may become inaccurate. This can make the apparatus more difficult for a user to interact with.

In order to account for this “slipperiness”, and meaningfully compare different combinations of electromagnet and permanent magnet, we introduce a property of “Maximum Practicable Static Rejection” (MPSR). MPSR can be considered as the maximum stable vertically rejecting force encountered across the device's vertical range that can be countered by a typical user's index finger to keep the finger attachment in equilibrium without diagonal slipping of finger and finger attachment becoming unavoidable. The value for MPSR is expressed in Newtons, and can depend upon a specific distance between the finger attachment and the base. In some examples, MPSR can be thought of as indicating the “practical output force range” of the device.

When performing rejection during interaction, the usefulness of a force output can be limited if the MPSR level (which may be empirically determined) is exceeded. For high rejection levels, the finger will typically either give in (and move upwards immediately) or slip (while equilibrium or downward movement is attempted). A rejection force that exceeds the MPSR level can lead to slippage, which can lead to partial reflection, which can lead to erroneous distance measurement, which can lead to a potentially un-resolvable ambiguity between intended/legal vertical movements and erroneous slips.

When performing level attraction during interaction, users may respond in one of two basic ways: they either counter the attraction, or they do not. Not countering may constitute passively giving in or actively going along, resulting in a downward movement. Countering is active and results in resisted (slower) downward movement, no movement, or upward movement. If the attraction level is too strong, going down may be the only possible type of outcome, but then the finger attachment will typically move towards the centre of attraction, the electromagnet core. When countering, upward movements will typically keep the finger attachment more or less straight above the core, even on a fast escape (there at least during the time spent within the vertical detection range). In some examples where human positioning control is breaking down, the finger will typically remain above the electromagnet core. Therefore, vertical position input and correct placement to receive further vertical force changes may not be broken, as when slipping on rejection. For these reasons, interactions designed with the system can be made to take into account eventualities resulting from arbitrary attraction levels. As described above, the same cannot be said for all eventualities resulting from arbitrary rejection levels. For the reasons given above, an imaginable, symmetric concept of “Maximum Practicable Static Attraction” may not be required in some embodiments.

The value for the MPSR level can be used in different ways. In one example the MPSR level/s can be stored in memory associated with the apparatus, and the converter can limit any rejection forces to the MPSR level if they would otherwise exceed the MPSR level. In other examples, when a user is programming the converter with details of distance/force profile that they require, any rejection forces that are in excess of the MPSR level may be rejected such that an alternative force value must be entered, or automatically limited to the MPSR level. During programming, a component (such as a processor or software) can automatically provide feedback to a user as to whether or not the MPSR has been exceeded such that the user can take appropriate action.

In further embodiments, the MPSR level can be used by a designer who determines and programs the desired interaction between the finger attachment and the base. For a specific embodiment, the person designing with the system can be provided with the MPSR value (a) via documentation (b) as an optional part of the system itself, for example a feedback signal telling running software it is (not) exceeding the MPSR output level.

In further still examples, the MPSR may again be stored in memory associated with the apparatus. In such examples, the apparatus may monitor/identify sudden changes in measured input distance (for example a determined distance changing by more than a threshold amount in a specified period of time), and automatically check whether the change(s) in distance coincide, or have coincided, with a system force output in excess of MPSR. The results of the check may provide an indication that the sudden change in distance is indicative of slippage due to an output force exceeding the MPSR level. If a slip due to exceeding the MPSR level is determined, the apparatus may activate an alert signal, which can be acted upon automatically in order to, for example, prevent, annul or amend the consequences normally resulting from a change in input distance as just observed. In this way, the MPSR level may be used to automatically detect and deal with the occurrence of erroneous slips (which are described above in relation to FIG. 6).

In one example, the electromagnet is configured such that it does not apply a force to the finger attachment, or does not change the force applied to the finger attachment, for a predetermined period of time after the slip is determined. In another example, the apparatus is configured such that a current is not supplied to the electromagnet, or does not change the current supplied to the electromagnet, for a predetermined period of time after the slip is determined.

Examples of permanent magnets with a symmetrical shape and uniform thickness can provide high values for MPSR (which can be considered as an advantage in some embodiments) when they are used with an electromagnet core having a cylindrical shape.

A first example shape of permanent magnet that was found to provide a high MPSR is a block with a square cross-section, for example a neodymium (N45) permanent magnet with dimensions of 20 mm×20 mm×3 mm. Such a magnet can enable a finger attachment with a total weight of 11 g to be provided.

A second example shape of permanent magnet that was found to provide a high MPSR is a disc with a circular cross-section, for example a neodymium (N35) permanent magnet with a diameter (Ø) of 20 mm and a thickness of 3 mm. Such a magnet can enable a finger attachment with a total weight of 8 g to be provided.

Increasing the permanent magnet's main surface area (that is the surface area that faces the base, when it is in use) was found to significantly increase the measured MPSR, and this can provide a finger attachment with decreasing “slipperiness”. This has been confirmed by performing tests with the following permanent magnets: square block, neodymium (N45), for dimensions:

15×15×3 mm→20×20×3 mm; and

circular disc, neodymium (N35), for dimensions:
Ø18×3 mm→Ø19×3 mm→Ø20×3 mm.

It has been found that increasing a permanent magnet's uniform thickness also increases the measured MPSR, and can also increase the output force range. This has been confirmed by performing tests with permanent magnets having thicknesses in the range of 2-5 mm.

In some examples, an array of electromagnets and proximity detectors may be provided, such that they can interact with a plurality of finger attachments, for example finger attachments attached to each of a user's fingers. The array may comprise a line of proximity detectors/electromagnets or a two-dimensional grid of proximity detectors/electromagnets. It will be appreciated that the number of finger attachments need not necessarily match the number of proximity detectors/electromagnets.

To enable multi-finger interactions, multiple fingers must each have their own permanent magnet attached. However, the sizes of, and forces between, these magnets should be selected so that they do not inhibit each other, and use of the apparatus with more than one finger.

Magnets that are too large and/or too strong can painfully press onto other fingers having magnets attached to the fingertips, or be tiring to a user who has to constantly apply a lateral force to keep the fingers apart, or prevent the fingers from being pulled apart (depending upon whether neighboring finger attachments attract or repel each other).

It has been found that, in order to retain multi-finger practicality, the dimensions of the main surface area of the permanent magnet that faces the base, in use, for a neodymium magnet should not exceed about a 20×20 mm square, or disc with about a 20 mm diameter. Within this range, it has been found that the upper limit in thickness for magnet lies between 3 mm and 4.5 mm.

For example, a neodymium (N35M) permanent magnet with dimensions of 20 mm×19 mm×4.5 mm has been found prohibitively impractical for multi-finger applications.

It will be appreciated that the requirements discussed above conflict at various points, and therefore, a number of trade-offs/compromises have to be decided upon. For example, for a given magnet material:

decreasing magnet volume can decrease magnet weight and size,

but there is a trade-off with the output force range, which will also decrease;

increasing magnet main surface area can increase MPSR,

but there is a trade-off with the weight of the finger attachment, and with multi-finger practicality;

increasing magnet thickness can increase MPSR,

but there is a trade-off with the weight of the finger attachment, and with multi-finger practicality.

Currently, these trade-offs have resulted in the use of the following two designs of permanent magnet, although it will be appreciated that other designs are possible and can perform the functionality disclosed herein:

Neodymium (grade N35 or higher), square block, 20×20×3 mm.

Neodymium (grade N35 or higher), circular disc, Ø20×3 mm.

In some examples, actuators (electromagnets) and detectors can be paired one-on-one, whereby each electromagnet is associated with its own separate dedicated position input and converter/controller. This can mean that systems employing device modules will have greater modularity than in situations where each electromagnet is not associated with its own separate dedicated position input and converter/controller).

Such examples can enable:
individual modules to be conveniently added, removed and reconfigured during development and use of interfaces comprising the device.
robust systems to be provided even if components of one of the modules are defective: There can be only a partial failure in the system's input and output when a defect occurs in one of its components (actuators and detectors).

Each electromagnet used can output a force in the area directly above and around it, and can be said to have its own sphere of influence where it separately outputs a force. Therefore, an array of multiple electromagnets may not be necessary to output one net force, instead each module/electromagnet can output its own force level (to one or more finger attachments present above the detectors).

FIG. 7 illustrates an embodiment of a finger attachment 704 according to another embodiment of the invention. The finger attachment of FIG. 7 will be used to describe an embodiment of a reflector 716a, 716b for reflecting infra-red (IR) light as discussed above.

The finger attachment 704 includes a strap 720 and a permanent magnet 718. Attached to the bottom (that is the surface that will be nearest the base when the finger attachment 704 is in use) of the permanent magnet 718 are two layers of material 716a, 716b that together provide the reflector. The first reflector layer 716a is a diffusely reflecting layer, such as paper, and is located nearest the IR light emitter in use. The second reflector layer 716b is a specular reflecting layer (or highly reflective layer, like a mirror), such as aluminium foil, and is located behind the first reflector layer 716a, in use.

The specularly reflecting second layer 716b may be mirror-coated transparent Perspex in some embodiments, and this can give good high-intensity infrared (IR) reflection at a given vertical distance from the sensor. This can be important because it can result in the widest/most precise vertical distance input range.

However, it has been found that using only a specular layer 716b has a disadvantage as changes in finger orientation can greatly influence the reflection intensity. This can be important as it is vertical finger proximity that should determine reflection intensity, and not the orientation of the finger attachment relative to the base. A solution provided by embodiments of the invention is to add a thin diffusely reflecting outer layer 716a on top of the specular inner layer 716b.

The reflector of this embodiment can provide advantages as it can be possible to provide good IR light reflection by the second specular reflector layer 716b in order for accurate distance determination to be achievable, whilst the first diffuser reflector layer 716a can account for any significant loss of reflected light due to the finger attachment not being parallel to the base (such as shown in FIG. 6b) as the first diffuser reflector layer 716a can enable light to be reflected across a range of angles/field of view.

Alternatively, one could say that reflection intensity of a diffusely reflecting layer 716a has been improved by adding an underlying specular layer 716b.

Materials that can be used for these two layers are: white paper (with a thickness of 0.10 mm) for the diffusely reflecting first reflector layer 716a; and aluminium foil (with a thickness of 0.013 mm) for the specular second reflector layer 716b. These materials are inexpensive and widely available, although they may wear easily and require regular replacement. It will be appreciated that these materials are purely exemplary, and that any other materials can be used for the reflector layers 716a, 716b that have the requisite properties in terms of being able to specularly and diffusely reflect light. It will be appreciated that in other embodiments, a single layer could be provided that has both the required properties in terms of specular and diffuse reflection of light.

In attaching the permanent magnet/IR reflector against the user's “fingerpad”, an objective can be to provide a precise fit with a user's finger (with no, or limited, leeway for unwanted displacements), which is still comfortable during use.

A circular enclosure that is attached to the top of the permanent magnet, and is configured to receive a user's fingertip in use, has been found to provide a comfortable fit. A good fit for a typical male index finger was found to be with a circular enclosure with a diameter (Ø) of about 19 mm (and smaller diameters for a typical female index finger).

It has also been found that for good vertical distance tracking, and vertical force projection, the finger attachment should cause the reflecting surface of the reflector (which is typically parallel to the permanent magnet) to be parallel to the top surface of the base for natural tapping movements of the user's finger. Typically, the top surface of the base shares its orientation with an end surface of the electromagnet core and also an upward-facing IR sensor surface.

Two examples of attachment means/straps include:

(1) hook and loop fasteners (such as Velcro strips) attached to the magnets sides, as shown in FIG. 5b; and

(2) first hook and loop fasteners attached to the magnets front and back, and a second hook and loop fastener that goes around the user's finger to hold the first hook and loop fasteners in place, as shown in FIG. 5a.

For the first example straps, it can be important to use the right angle-to-magnet-surface for the hook and loop fastener side strips. It has been found that an angle of about 35° provides good performance.

An advantage associated with the second example straps, is that the angle between the user's finger and the plane of the permanent magnet is more readily adjustable to suit a user's needs.

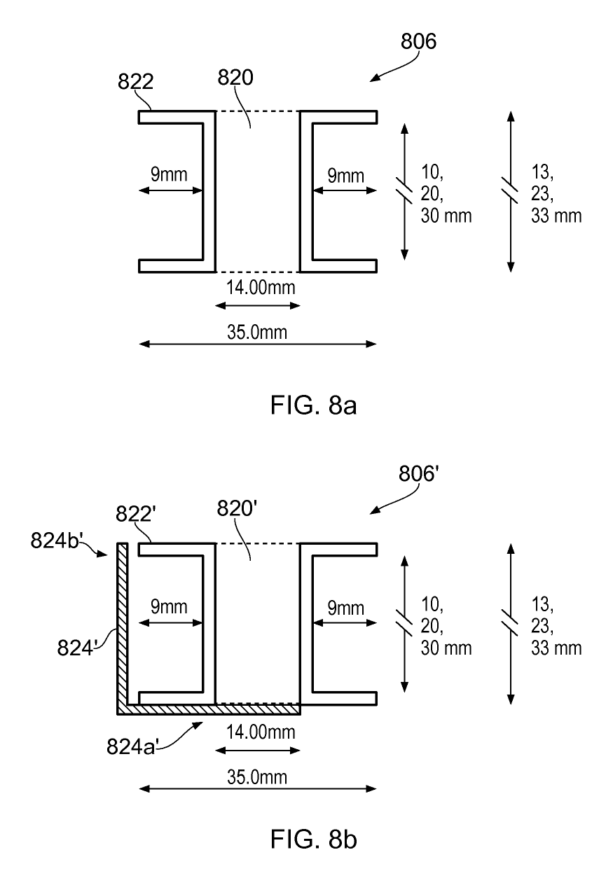

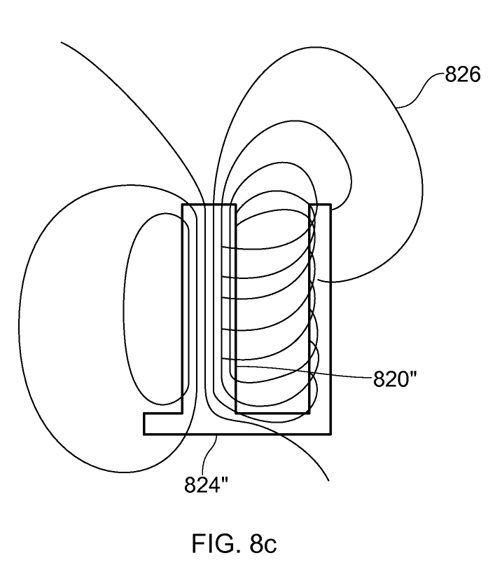

FIG. 8a illustrates a cross-sectional view through an electromagnet 806 according to an embodiment of the invention. The electromagnet 806 comprises a spool 822, around which is wound a coil wire, such as copper coil wire (not shown in FIG. 8a). At the centre of the spool is a core 820.

In this example, the electromagnet 806 has a cylindrical steel core 820 with a 14 mm diameter circle in cross-section. Around the core 820 is the spool 822, and a 1 mm diameter copper coil wire is wound around the spool to a thickness of about 9 mm. The spool is made of a standard pertinax-type material. The resulting electromagnet 806 has a total coil diameter of about 35 mm (including the thickness of the spool).

It has been discussed above how smaller surface areas of the permanent magnet of the finger attachment have been found to result in increased “slipperiness” of the finger attachment above the base, and this has been considered in terms of a decreased practical output force range (MPSR).

It has similarly been found that the surface area of the electromagnet's core 820 that faces the finger attachment can influence the slipperiness and MPSR of interactions between the finger attachment and electromagnet. The dimensions of the electromagnet identified above have been found to work well with the example magnet dimensions identified above.

In addition to the dimensions of the electromagnet 806 in cross-section, it has been found that the height of the electromagnet 806 affects the achievable output force range. Tall electromagnets 806 can provide a large output force range, although in some embodiments this may be a trade-off as short electromagnets 806 may be advantageous as they do not occupy too much volume. For the cross-sectional dimensions identified above, electromagnets 806 with a coil height of 10 mm, 20 mm and 31 mm were tested, and it was found that a coil height of 31 mm provided a sufficient force output range.

It will be appreciated, that the dimensions and materials discussed above are merely illustrative, and can be adapted for specific applications of the apparatus.

FIG. 8b illustrates another electromagnet 806′ according to an embodiment of the invention. The electromagnet 806′ of FIG. 8b is similar to that of FIG. 8a, and common components will not be described in detail again here. In addition to the core 820′, spool 822′ and wiring (not shown in FIG. 8b), the electromagnet 806′ has a fourth main component; a bridge 824′ of magnetizable material. The bridge 824′ is connected to a bottom surface of the core 820′ at a first end 824a′, and a second end 824b′ of the bridge 824′ is located near the opposite/top end of the core 820. The second end 824b′ of the bridge 824′ may be considered as a free-end, and the top surface of the core 820′ may be considered as a free-end. The bridge 824′ may be a bent shape so that its free end 824b′ becomes located near a top surface of the core 820′. In this way, the “free-end” 824b′ of the bridge 824′ and “free-end” of the core 820′ are located in substantially the same plane, however without physically connecting the two together.

A custom steel hook of 2.4 mm thickness can be used as the bridge 824′ of magnetizable material.

The bridge 824′ of magnetizable material can be used to place both the electromagnet's 806′ north and south pole at the surface of the base, and this can concentrate magnetic field strength (at the surface of the base) to provide a greater achievable output force range.

In one example, the act of adding a (custom hook) bridge component 824′ was found to increase measured magnetic field strength above the electromagnet core by 32% to 41%.

FIG. 8c shows the result of a 2D simulation of the areas of magnetic flux of the magnetic field 826 of a core 820″ and bridge component 824″ according to an embodiment of the invention. The 2D simulation can be regarded as approximating a cross-section of the 3D magnetic field involved. This illustrates the type of resulting magnetic field from a core 820″ and bridge 824″ combination, which is different from that of an electromagnet without a bridge.

During use of the electromagnet 806′ shown in FIG. 8b, with the co-located electromagnet north and south pole surfaces placed in the same plane, forces may be projected in opposing directions on the nearby finger magnet. A rejecting force may have an attracting force nearby, and vice versa. It is not trivial to be able to successfully implement such an electromagnet in practice. Therefore, determining a specific shape and size for the bridge, which achieves a reliable and wide-ranging net output force range on finger magnets, can be regarded as an embodiment of the invention.

In order for the electromagnet to generate a magnetic field, a coil current is passed through the copper coil wire around the spool 822. Given an electromagnet of a certain height, the magnetic field strength of its output is determined by the coil currents used, and in this example, an electrical current in the range of −10 to +10 A was used.

Embodiments of the electromagnet disclosed herein can be used with a coil current comprising a 500 Hz sine wave. It has been found that a 500 Hz sine wave can enable the full range in the expected force output to be achieved during a single sine wave cycle. This can provide at least the following two advantages:

within 1 ms (that is, the duration of half a 500 Hz cycle), the electromagnet can go from any output force level within its range to any other. This can be important for the total latency between haptic input (movement of the finger attachment) and output (force applied to the finger attachment), and may be considered as an acceptable delay.

the apparatus can cover, and give precise control, in the 0-400 Hz frequency range, which is known to be associated with the human skin-based sense of vibration. In this frequency range, the frequency characteristic of the system's magnetic output is substantially flat (having a 5% dip in the middle), which can mean that output specified for cutaneous or other feedback that employs different frequencies but similar wave amplitudes, will indeed result in similar wave amplitudes in the actual variations in magnetic field strength. The frequency characteristic in the range 0-400 Hz is also substantially linear, which means that output specified for cutaneous or other feedback that employs different wave amplitudes but the same frequency, will indeed result in wave amplitudes in the actual variations in magnetic field strength which correspond to the intended relative scaling.

In some embodiments, the apparatus can provide feedback in the form of an additional signal in software, indicating the force level that is actually being achieved (independently of vertical distance). The system can know its output force range for any finger attachment proximity (within the distance detection input range). Given a currently unachievable force level specified for output, it can clip (decrease the absolute value of) this level to the nearest available level. This can be a useful tool for interaction design, as it can enable verification that the force levels computed for some interaction indeed remain within the actual force range of the apparatus (which is dependent on vertical distance). An example of a force range for an apparatus may include limitations due to a determined MPSR level representative of the “slipperiness” of interactions between the finger attachment and base.

In some embodiments, a velocity input can be derived from the proximity detection signal. That is, the velocity of the finger attachment can be determined by differentiating the determined distance with respect to time. In this way, a future position of the finger attachment, based on the current velocity and distance, can be determined and an output force signal can be determined accordingly. This can improve the latency of the apparatus, and enable output forces to be determined more quickly. In some embodiments, zero (or near-zero) audio and tactile latency may be achieved, and this can be particularly advantageous for musical applications that include percussive-type interactions. A velocity input signal may be used to predict arrival at a certain vertical distance above the base surface, and using their known separate latencies, audio and tactile output can then each be “prescheduled” to create the equivalent of a direct, simultaneous response.

Embodiments of the invention that use the finger attachment's direct position and speed input signals and force output signal can enable the emulation of the stiffness and damping characteristics of many existing tactile devices. Examples of such tactile devices include buttons and keys of various types of keyboard (e.g. computer, musical). In some cases, the measurements of such characteristics may be readily found in published literature.

Emulation of such programmable tactile profiles can be implemented using static or dynamically changing look-up tables, for example of output force over input distance, or output force over input speed, to determine the force to be applied to the finger attachment.

Use of an electromagnet to provide haptic feedback to a user can be considered as advantageous when compared with motor driven haptic feedback, as the mechanical properties related to internal movement of the motor can negatively affect the accuracy with which the desired haptic feedback can be provided to a user.

Embodiments of the invention can provide an untethered approach for receiving and providing haptic signals, which can be free from moving mechanical linkages. Cutaneous and/or kinesthetic force feedback in N can be delivered to a human finger (such as the fingertip) with high temporal precision and high precision in terms of amplitude.

Embodiments disclosed herein can be considered as providing a novel platform for finger-based tactile interaction research. An operating principle is to track vertical fingerpad position above a freely approachable surface (possibly an aperture in the surface), while directly projecting a force on the same fingerpad. The projected force can be specified in Newtons, with high temporal resolution. In combination with a relatively low overall latency between tactile input and output, this can be used to work towards the ideal of instant programmable haptic feedback. This can enable support for output across the continuum between static force levels and vibrotactile feedback, targeting both the kinesthetic and cutaneous senses of touch.

One or more embodiments disclosed herein can be used to interact with a virtual surface, such as Microsoft Surface. Also, one or more embodiments disclosed herein can be used to interact with a surface comprising a projected or integrated general-purpose visual display. Use of IR can be advantageous in such embodiments, as it minimizes mutual interference between the visible light of a display and the IR light that is used for detector sensing, which is invisible to the human eye. In such examples, the functionality of the surface can be expanded such that a user can interact with the surface using their sense of touch (haptics). The “surface” can be configured such that it is a top surface of a “base” as disclosed herein.

Embodiments disclosed herein can be configured to work with any device having a display or touch sensitive screen. In one example, haptic feedback can be provided to imitate a keyboard, where the user can “feel” virtual keys that may be displayed on the display or touch sensitive screen. In some embodiments, the screen may not need to be touch sensitive as user input can be determined from haptic input signals. It is known that typing speeds are higher where a user receives haptic/tactile feedback as opposed to auditory or visual feedback. The faster human response to haptic/tactile feedback when compared to auditory or visual feedback may be similarly advantageous when manipulating arbitrary virtual objects in tabletop or other interfaces. Therefore, one or more embodiments disclosed herein can provide an improved user interface, such as a virtual keyboard, that can provide tactile/haptic feedback to a user.

In some embodiments, the base can be incorporated into any existing or potential control surface for usage scenarios where such surfaces are placed within a human's arm, hand or finger reach. This can include examples where gloves are not used, scenarios where gloves can be used, and scenarios where gloves are already in common use.

In examples where gloves can be used or are commonly used, the finger attachment can be incorporated into, or be an extension to the gloves, possibly a temporary/removable extension.

The following examples indicate potential applications of embodiments of the invention where gloves may or may not be (already commonly) used, and application with or without gloves may be possible: The {dashboards, instrument panels or any other control surfaces} of {motor vehicles, trains, boats, airplanes, helicopters, spacecraft or any other vehicles; industrial devices and machinery; domestic appliances; existing or future virtual reality setups (which may employ (data) gloves); computer systems or entertainment devices; professional or consumer electronics; sports gear; or any previously non-interactive surface that is to be extended with haptic feedback for human control}.

In this context, it may be noted that, in embodiments where the base has a closed surface (for example, a detection aperture covered by glass or other transparent material) the apparatus according to an embodiment of the invention may give an advantageous way of providing input and haptic feedback for control (thereby adding new, or replacing existing controls). For situations where dirt or wear is an issue; a completely sealed control surface can be desirable; a control surface without moving parts is desirable; or the direct contact with control surfaces may be impractical. Examples could include industrial applications, or devices operated underwater. One or more of these desires can be met by an embodiment of the invention where the base does not have an aperture in its surface, that is, it has a continuous surface that covers the proximity detector and electromagnet.

As discussed above, in some embodiments the base may comprise both the electromagnet and detector. It has been appreciated that it can be advantageous to locate the detectors and actuators under the surface of the base. In this way, no system components (apart from the finger attachment) are located above, or extend above, the surface of the base in the sense of having a molecular presence there. Of course, they may be considered as having a presence outside the base in terms of the electromagnetic field and reflected IR beam. This can provide one or more of the following examples:
Advantage 1: the absence of potential obstacles for user movement maximizes free user movement and approachability of the device's haptic input/output (I/O) above, and from all sides above, the surface of the base.
Advantage 2: fingers, hands and arms or other body parts cannot get in the way of detection to the extent they could with alternative detector placement above and/or around the device surface.

Advantage 1 and 2 can allow the apparatus to better support scenarios where one or more users may be located around the device and interact with it, for example in a tabletop setup. Also, these advantages can support more comfortable, natural and uncomplicated operation, by placing less physical constraints on device operation.

In some embodiments, the finger attachment could be replaced by an attachment to any other part of the human body, and may be referred to as a “body attachment” instead of a finger attachment. The part of the human body may be a finger, toe, hand, foot or any other body part that is able to receive cutaneous or kinesthetic feedback, or any other type of haptic or force feedback. The body attachment may be provided as part of a glove, sock, footwear, or any other article of clothing.

In examples where the apparatus is configured for instrumental musical interaction, or in any other (instrumental) context, the following features may be applicable to embodiments of the invention:
The apparatus may be used to simulate (aspects of) the tactile behaviour of piano keys and musical keyboard actions in general. For example, the apparatus may simulate the set of moving mechanical parts in a keyboard instrument which transfer the motion of the key to the sound-making device.
The apparatus can provide advantages in relation to making any simulated aspects dynamically, instantaneously and fully adjustable; and/or making any simulated aspects free from mechanical wear and unintended variation.
There exists a class of musical instrumental interfaces where moving to and from a freely approachable device surface using the arms, hands and fingers is part of standard (common) musical instrumental interaction with the device. An example of this class of devices is the Theremin. A known issue with such devices is that their lack of haptic and tactile feedback makes precisely controlled spatial input and thereby musical sound output hard to achieve for the user. An apparatus according to an embodiment of the invention can address this issue as it can provide tactile feedback across spatial distance above a freely approachable device surface.
An example of tactile feedback that can be provided (possibly with the Theremin example) includes the generation of force pulses by the apparatus at fixed or dynamically determined spatial intervals during traversal of the distance input range during interaction.
The apparatus may be configured to generate fixed, dynamically adjustable or variable counter-forces to user movement, thereby providing more precision in input and control.
Using a counter-force can mean that a given range of input force applied by the user via the finger attachment will translate into smaller displacements. This can provide the following advantages: making better use of the available spatial detection precision of the apparatus; and/or making better use of the user's input force range, with input movements associated with larger input forces remaining within the device's detection range.
In general, the apparatus can provide advantages of integrated tactile synthesis for musical interaction, for example by enabling a different tactile feel for different musical output modes. Consider, for example, how existing electronic keyboards will tactually feel the same during the use of different sets of musical sounds: the apparatus of an embodiment of the invention can provide a different feel for different sets of musical sounds, or musical output modes. This provides at least advantages regarding fast and convenient identification of musical output modes during use, and may also improve the overall aesthetic experience of interacting with the musical instrument.
The apparatus can be used as a tactile metronome or for haptic tempo and rhythm feedback in general. For example by periodically applying a vibration force to a user. This can be (as can be found in literature) an aid in learning and performing musical (poly)rhythms.
Designers creating interactions with systems containing the apparatus will appreciate that the feel of the resulting instrument is easily controllable in a way that is conceptually similar to existing practices for (musical) sound generation.
In addition to a signal of audio-amplitude-over-time (always present in some form in any system generating loudspeaker audio output), now a conceptually similar force-over-time signal can be provided as well. This can mean that both technically and conceptually, tactile and audio synthesis can instantly and conveniently be integrated during design and use, or be used separately but in a similar way. For example, tactile events can now be “played back” on the device just as audio fragments (which may be known as “samples”) are commonly played back on loudspeakers.
Tactile signatures may be actively output by the apparatus before, or during, use and this may be while other system output (such as sound), is not yet active. For example, tactile signatures can be output upon detecting user presence in the input distance range of the apparatus, and this may aid the user in orientation and correct operation of controls.
For example, in musical interactions (for example involving playing keyboard keys) or other interactions (for example involving typing) a common source of errors may be the wrong fingers acting with the right timing, in the sense of two or more fingers having their correct temporal order of execution permutated into an erroneous one. Providing programmable and dynamically activated tactile signatures to the fingers involved before and during use may help prevent such errors from occurring.

While this invention has been particularly shown and described with references to example embodiments thereof, it will be understood by those skilled in the art that various changes in form and details may be made therein without departing from the scope of the invention encompassed by the appended claims.

What is claimed is:

1. Apparatus comprising:
a base;
a finger attachment; and
an electromagnet;
wherein the base comprises a proximity detector configured to determine a distance between the finger attachment and the base;
the apparatus further comprising a converter configured to convert the distance between the finger attachment and the base into a force to be applied to the finger attachment; and
wherein the electromagnet is configured to apply a force to the finger attachment in accordance with the force to be applied to the finger attachment as determined by the converter.

2. The apparatus of claim 1, wherein the output force comprises a first force component that is configured to move the finger attachment, thereby changing the distance between the finger attachment and the base.

3. The apparatus of claim 2, wherein the output force comprises a second force component that is configured to vibrate the finger attachment, thereby not substantially changing the distance between the finger attachment and the base.

4. The apparatus of claim 1, wherein the converter is configured to convert the distance between the finger attachment and the base into a force to be applied to the finger attachment using a look-up table of data values.

5. The apparatus of claim 1, wherein the converter is further configured to convert the force to be applied to the finger attachment to a driving current/voltage for the electromagnet.

6. The apparatus of claim 5, wherein the converter is configured to use a look-up table to determine the driving current for the electromagnet based on the distance between the finger attachment and the base and the force to be applied to the finger attachment.

7. The apparatus of claim 6, wherein the data in the look-up table is determined empirically.

8. The apparatus of claim 1, wherein the finger attachment is mechanically independent from the base.

9. The apparatus of claim 1, wherein the finger attachment comprises a magnet for experiencing the force from the electromagnet.

10. The apparatus of claim 1, wherein the finger attachment comprises a reflector configured to reflect light that is received from the proximity detector, back to the proximity detector, such that the proximity detector can determine the distance between the finger attachment and the base.

11. The apparatus of claim 10, wherein the reflector comprises a first and second layer reflector layer; wherein the first layer is a specular reflector layer, and the second reflector layer is a diffuse reflector layer.

12. The apparatus of claim 1, wherein the converter is configured to convert the distance between the finger attachment and the base into a zero force that is to be applied to the finger attachment.

13. The apparatus of claim 1, wherein the converter is configured to convert the distance between the finger attachment and the base into a force that will bias the finger attachment to a predetermined distance from the base.

14. The apparatus of claim 1, wherein the converter is configured to periodically sample the distance between the finger attachment and the base, and only convert the distance between the finger attachment and the base into an updated force to be applied to the finger attachment if the difference between (1) a current value for the distance between the finger attachment and the base and (2) the last value for the distance between the finger attachment and the base that was converted into a force, is in excess of a sensitivity threshold value.

15. The apparatus of claim 1, wherein the converter is configured to determine the velocity of the finger attachment from the determined distance between the finger attachment and the base, and determine the force to be applied to the finger attachment using both the velocity of the finger attachment and the determined distance between the finger attachment and the base.

16. The apparatus of claim 15, wherein the converter is configured to determine the force to be applied to the finger attachment for a future instance in time in accordance with the velocity of the finger attachment and the determined distance between the finger attachment and the base.

17. The apparatus of claim 9, wherein the electromagnet is configured to apply a time-varying force to the finger attachment, and the apparatus further comprises:
a finger coupler coupled to the magnet, wherein the finger coupler is configured to be located between the magnet and a user's finger in use such that vibrations are coupled from the magnet to the user's finger;
wherein the finger coupler is configured to interact with different mechanoreceptors in the user's finger over time.

18. The apparatus of claim 17, wherein the finger coupler comprises a rough or uneven surface, or a deformable surface/layer.

19. A musical device comprising the apparatus of claim 1, wherein the base represents a musical instrument, and a user can interact with the base by moving, or attempting to move, or holding still the finger attachment relative to the base while a force is applied to the finger attachment by the electromagnet.

20. A user interface comprising the apparatus of claim 1, wherein the base represents a display, and a user can interact with the base by moving, or attempting to move, or holding still the finger attachment relative to the base while a force is applied to the finger attachment by the electromagnet.
